(19) United States
(12) Patent Application Publication
(10) Pub. No.: US 2014/0066564 A1
(43) Pub. Date: Mar. 6, 2014

(54) Molded Articles Made From A Translucent Polymer Composition

(71) Applicant: Ticona LLC, Florence, KY (US)

(72) Inventors: Mukul Kaushik, Florence, KY (US); Dirk Zierer, Hofheim (DE); Tilo Vaahs, Idstein (DE)

(73) Assignee: Ticona LLC, Florence, KY (US)

(21) Appl. No.: 14/020,033

(22) Filed: Sep. 6, 2013

Related U.S. Application Data
(60) Provisional application No. 61/780,460, filed on Mar. 13, 2013.
(60) Provisional application No. 61/697,571, filed on Sep. 6, 2012.

(51) Int. Cl. C08L 67/02; C08K 9/02; C08K 3/36

(52) U.S. Cl. CPC C08L 67/02; C08K 3/36; C08K 9/02
USPC 524/449; 524/605; 524/504; 524/492

(57) ABSTRACT

A translucent polymer composition is described that contains a thermoplastic polymer combined with an impact modifier. The thermoplastic polymer may comprise a polyester copolymer that is substantially amorphous. The impact modifier may have a core and shell construction and may be configured so as to substantially match the refractive index of the polyester polymer. The polymer composition may also contain at least one stabilizer, an anti-scratch additive, a glitter-like additive, in addition to other components. In one embodiment, the polymer composition substantially blocks ultraviolet rays. In particular, the polymer composition can be formulated so that within the ultraviolet light wavelength range, the polymer composition displays 0% transmission or less.

### RELATED APPLICATIONS

This application claims filing benefit of U.S. Provisional Patent Application Ser. No. 61/780,460, filed on Mar. 13, 2013, and U.S. Provisional Patent Application Ser. No. 611697,571, filed on Sep. 6, 2012, and which are both incorporated herein in their entirety.

### BACKGROUND

Thermoplastic polymers are a class of useful materials that have a unique combination of properties. The materials, for instance, can be formulated so as to have various physical properties. The materials can also be melt processed due to their thermoplastic nature.

Thermoplastic polymers are used in numerous applications. The materials, for instance, may be molded to form a particular part or product. Thermoplastic polymers, for instance, are used to make components and products in many different fields including sports equipment, automotive parts, consumer appliance parts, industrial parts, and the like.

Some thermoplastic polymers are translucent or even transparent. For example, some amorphous or semi-crystalline polymers are known to have translucent properties. Translucent properties are desired or needed in certain applications. For instance, translucent polymers may have a functional purpose and/or may improve the overall aesthetic appeal of a product.

Many translucent polymers, however, have physical property limitations. For instance, many thermoplastic polymers with translucent properties have inferior impact resistant properties, especially at lower temperatures.

Another problem is that many translucent polymers have a relatively narrow operating temperature range. For instance, the physical properties of the polymers have a tendency to vary as the temperature changes. For example, the polymers may increase in stiffness at lower temperatures which can adversely impact their usefulness.

In view of the above, a need exists for a translucent polymer composition that has improved physical properties, such as impact strength. In particular, a need exists for a method of improving the physical properties of a translucent thermoplastic polymer without adversely affecting light transmission through the material at desired wavelength ranges.

### SUMMARY

The present disclosure is generally directed to a polymer composition and to molded products made from the composition that have translucent and/or transparent properties. The polymer composition, for instance, can be formulated in accordance with the present disclosure so as to have a maximum transmission within a wavelength range of from about 400 nm to about 900 nm of greater than about 60%, meaning that at least one point between a wavelength range of from about 400 nm to about 900 nm, the polymer composition displays a percent transmission of greater than about 60%, such as greater than about 62%, such as even greater than about 65%. In accordance with the present disclosure, in addition to being translucent, the polymer composition also has good impact resistance. In particular, the polymer composition also has a notched Charpy impact strength at 23° C. of greater than about 3.5 kJ/m², such as greater than about 4 kJ/m², such as greater than about 4.5 kJ/m², such as greater than about 5 kJ/m².

The polymer composition comprises a substantially amorphous polyester polymer present in the composition in an amount sufficient to form a continuous phase. The polyester polymer may comprise a polyalkylene terephthalate copolymer, such as a polyethylene terephthalate glycol-modified copolymer (PET-G) containing cyclohexane dimethanol or a polyethylene terephthalate glycol-modified copolymer containing neopentyl glycol, or a polyethylene terephthalate glycol-modified copolymer containing 2-methy-1,3-propane diol. The polyester polymer may comprise a polyalkylene terephthalate copolymer, such as a polyethylene terephthalate acid-modified copolymer (PET-A) containing isophthalic acid or a polyethylene terephthalate acid-modified copolymer containing cyclohexane dicarboxylic acid. The polyester polymer may comprise a polyalkylene terephthalate copolymer, such as a polyethylene terephthalate glycol- and acid-modified copolymer containing cyclohexane dimethanol and isophthalic acid, or other combinations.

The polymer composition further contains an impact modifier. The impact modifier can be present in the composition in an amount of at least about 15% by weight. In accordance with the present disclosure, the impact modifier has a refractive index that is within about 5% of a refractive index of the polyester polymer. In one embodiment, the impact modifier may have a core and shell construction wherein the core comprises a cross-linked diene-based elastomer and the shell comprises a thermoplastic polymer.

The polymer composition may also contain at least one stabilizer. In one embodiment, the polymer composition may contain an anti-scratch additive, such as silica particles.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of one embodiment of a snow ski boot made in accordance with the present disclosure;

FIG. 2 is a side view of the snow ski boot illustrated in FIG. 1;

FIG. 3 is a cross-sectional view of another embodiment of a snow ski boot made in accordance with the present disclosure; and

FIGS. 4-6 are graphical representations of percent transmission for selected examples described below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polymer composition and to molded polymer articles that not only have translucent properties but also have improved physical properties, such as impact resistance. In one embodiment, the polymer composition of the present disclosure may be formulated so as to have desired and stable physical properties over a wide temperature range.

In general, the polymer composition of the present disclosure comprises a thermoplastic polymer that may be characterized as non-elastomeric and is provided in the composition for providing rigidity and stability. The thermoplastic polymer is generally present in the polymer composition in an amount sufficient to form a continuous phase when the composition is molded into an article. In accordance with the present disclosure, the thermoplastic polymer has translucent properties. In particular, a polymer is selected that has relatively high transmission values within the visible light spectrum. In addition to a thermoplastic polymer, the polymer composition can contain various other components depending upon the particular application and the desired result. For instance, the polymer composition can contain at least one impact modifier. In addition, the polymer composition may contain at least one additive that provides scratch resistance and particularly abrasion resistance. As will be described in greater detail below, the components combined with the thermoplastic polymer are carefully selected and configured so as not to significantly and adversely affect the translucent properties of the polymer. In one embodiment, additives may also be incorporated into the composition that further enhances the translucent nature of the polymer composition.

Polymer compositions made in accordance with the present disclosure can be used in numerous and diverse applications. The polymer composition, in one embodiment, can be used as a coating on a surface. Alternatively, various articles and products can be produced from the polymer composition. Of particular advantage, the polymer composition can be molded into any suitable shape. For instance, the polymer composition can be used in an injection molding process. Such products can include sporting equipment. In one embodiment, the polymer composition may be used to produce sporting equipment that is used in low temperature environments, such as sporting equipment used in winter sports activities. The polymer composition of the present disclosure, for instance, can be formulated so as to have relatively stable properties at lower temperatures.

The polymer composition of the present disclosure may also be used to produce various other products. Such products include translucent pipes for agriculture and industrial use, outdoor lighting products including lamp shades, multi-layer films that are not only translucent but provide ultraviolet protection, pump housings, cosmetic packaging, toys including gaming consoles, keyboards, handles, and the like. The polymer composition of the present disclosure may also be used as a component in electronic devices.

As described above, the polymer composition can be formulated so as to be well suited for use in low temperature environments. In this embodiment, the polymer composition may be used to produce sportswear and sports goods that are used in winter environments and/or snow removal device. In one embodiment, the polymer composition can be used to produce molded boots, particularly boots for ice skates, hockey skates, and snow skis.

In one particular embodiment, as shown in the figures, the polymer composition may be used to produce snow skiing boots. Snow ski boots made in accordance with the present disclosure have a unique appearance and aesthetic appeal due to the translucent nature of the polymer composition. In fact, pearl or glitter-like material may also be incorporated into the composition for further enhancing the look of the product.

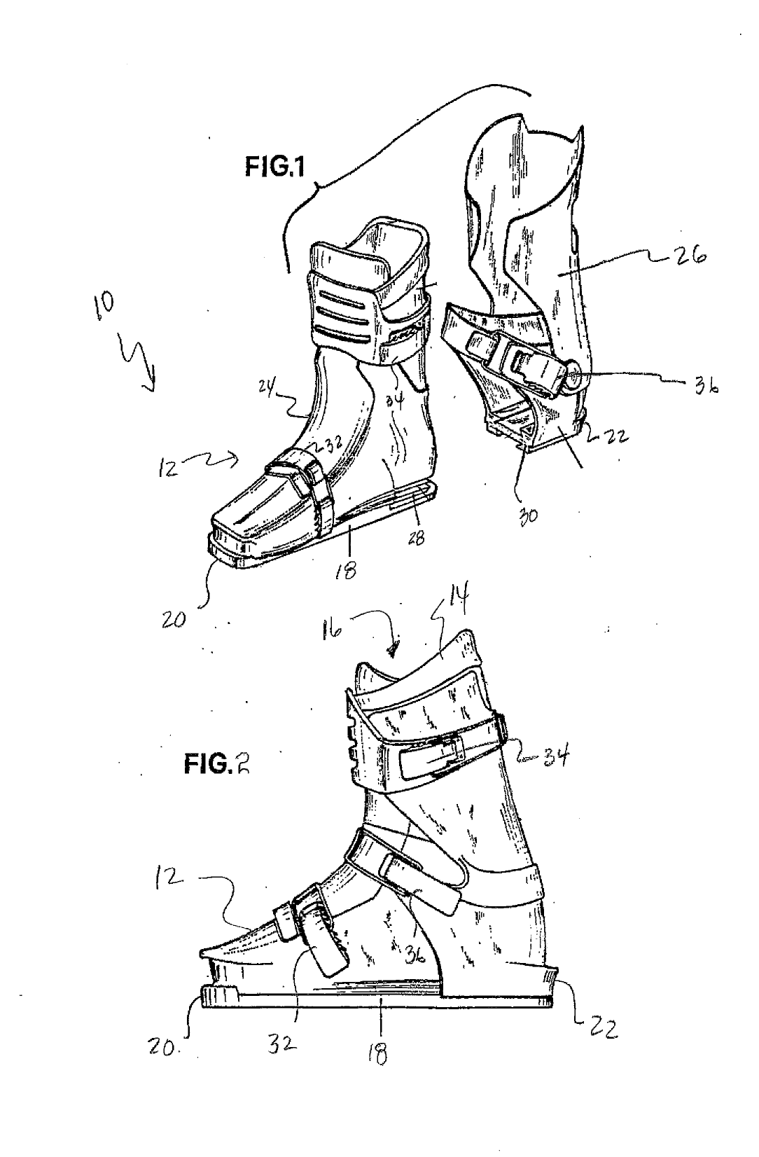

Referring to FIGS. 1 and 2, for instance, one embodiment of a ski boot 10 made in accordance with the present disclosure is shown. The ski boot 10 includes a rigid outer shell 12 made from a polymer composition in accordance with the present disclosure. The outer shell 12 includes an exterior surface and an interior surface. The interior surface may be placed adjacent to lining 14. The lining 14 may be permanently attached to the outer shell 12 or may be removable from the outer shell. The outer shell 12 and the lining 14 of the ski boot 10 defines an opening 16 for receiving the foot of a wearer.

As shown in FIGS. 1 and 2, the outer shell 12 forms a sole 18. The sole 18 has a shape configured to engage the bindings of a ski. In particular, the sole 18 includes a front flange 20 and a back flange 22. The flanges 20 and 22 can have any suitable shape such that they will cooperate with bindings on a ski and releasably detach from the skis should the skier fall during use.

In the embodiment illustrated in FIGS. 1 and 2, the outer shell 12 of the ski boot 10 is made from two separate pieces. In particular, the outer shell 12 includes a boot portion 24 and a cuff portion 26. The boot portion 24 and the cuff portion 26 can be made from the same polymer composition. In an alternative embodiment, however, different polymer compositions may be used that have different but complementary properties, such as flexural modulus properties.

As shown in FIG. 1, the boot portion 24 of the ski boot 10 includes grooves 28 that cooperate with ribs 30 on the cuff portion 26 for interlocking the two pieces of the boot together. If desired, the cuff portion 26 can be permanently attached to the boot portion 24 through screws or other attachment devices that may extend from the bottom of the boot and through the two portions.

In the embodiment illustrated in FIGS. 1 and 2, the ski boot 10 includes three buckles. The first buckle 32 is positioned on the toe portion of the ski boot. The second buckle 34, on the other hand, is positioned higher on the ski boot and is intended to secure the ski boot to the lower leg of a wearer. The cuff portion 26 further includes a third buckle 36 that wraps around the ankle of the wearer. The third buckle 36 also further serves to integrate the cuff portion 26 with the boot portion 24.

In accordance with the present disclosure, the outer shell 12 of the ski boot 10 is made from a polymer composition that has stable physical properties at lower temperatures. In one embodiment, the outer shell of the ski boot 10 may be made from the polymer composition and may have a resulting flexural modulus of from about 700 MPa to about 2500 MPa at 23° C. In high performance applications, a higher flexural modulus may be preferred. For example, the flexural modulus may be greater than about 1000 MPa, such as greater than about 1200 MPa.

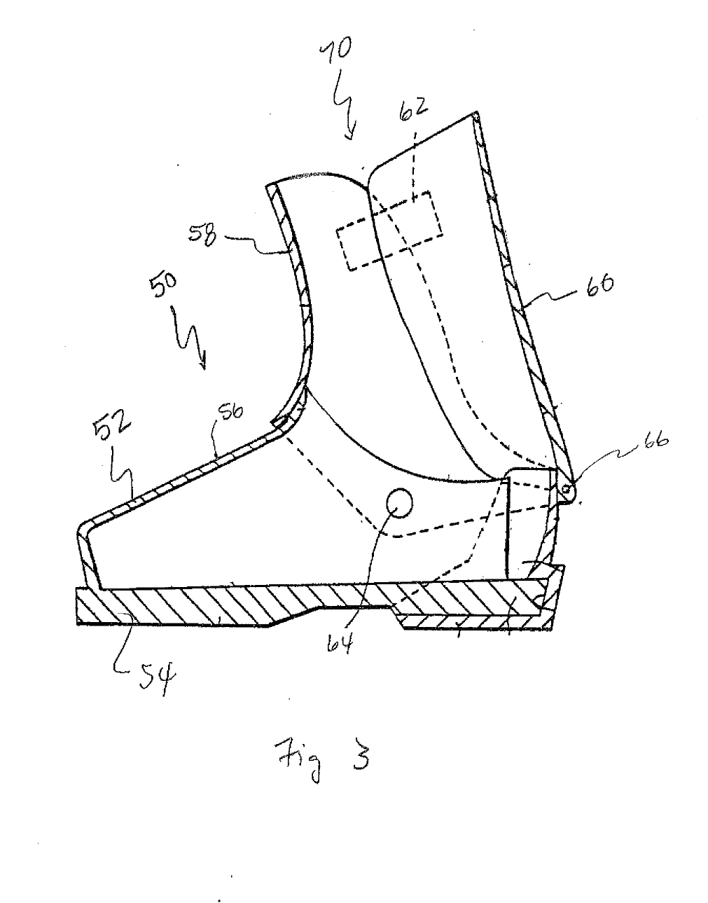

Referring to FIG. 3, another embodiment of a ski boot 10 made in accordance with the present disclosure is shown. In this embodiment, a cross-sectional view of the boot is illustrated. The ski boot 50 shown in FIG. 3 is referred to in the art as a “rear entry” ski boot in that the boot includes a rear portion that pivots for allowing one to insert his or her foot.

As shown in FIG. 3, the ski boot 10 includes a rigid outer shell 52 made in accordance with the present disclosure. Not shown, the ski boot 50 may also include a lining that lines the hollow interior cavity of the outer shell 52. The outer shell 52 also defines a sole 54 that has a shape configured to engage the bindings of a ski.

In the embodiment illustrated in FIG. 3, the outer shell 52 of the ski boot 50 is made from multiple parts. The outer shell 52 includes a boot portion 56 attached to a front cuff 58 and to a rear cuff 60. The front cuff 58 and the rear cuff 60 are tightened around a skier's lower leg during use. For instance, in one embodiment, the ski boot 50 may include a buckle 62 for adjustably tightening the front cuff 58 together with the back cuff 60.

The front cuff 58 is pivotally attached to the boot portion 56 about a pivot element 64. The rear cuff 60, on the other hand, may be attached to the boot portion 56 by a pivot element 66. In this manner, the rear cuff 60 can be pivoted backwards to expose an opening 70 for receiving the foot of a wearer.

In the embodiment illustrated in FIG. 3, each of the different sections of the ski boot may be attached to a different liner for providing cushion and comfort to the wearer. Alternatively, a one-piece liner may be inserted into the boot for surrounding the foot and ankle of a wearer.

Similar to the embodiment illustrated in FIGS. 1 and 2, the outer shell 52 of the ski boot 50 is also made with a polymer composition in accordance with the present disclosure. As described above, the polymer composition generally contains a non-elastomeric thermoplastic polymer that has translucent and/or transparent properties. In accordance with the present disclosure, the thermoplastic polymer is combined with an impact modifier. The impact modifier is selected or configured so as to preserve the translucent properties of the composition while still increasing impact resistance. In addition to an impact modifier, the polymer composition can optionally contain one or more stabilizers, an anti-scratch additive, and/or an optical additive, such as an optical brightener or special effect additive.

As described above, the base polymer or resin for the polymer composition of the present disclosure is generally transparent and/or translucent. The thermoplastic polymer is generally present in the composition in an amount sufficient to form a continuous phase when the polymer composition is molded into a product. In one embodiment, the thermoplastic polymer comprises a polyester, particularly a copolyester.

The polyesters which are suitable for use herein are derived from an aliphatic or cycloaliphatic diol, or mixtures thereof, containing from 2 to about 10 carbon atoms and an aromatic dicarboxylic acid, i.e., polyalkylene terephthalates.

The polyesters which are derived from a cycloaliphatic diol and an aromatic dicarboxylic acid are prepared by condensing either the cis- or trans-isomer (or mixtures thereof) of, for example, 1,4-cyclohexanedimethanol with the aromatic dicarboxylic acid.

Examples of aromatic dicarboxylic acids include isophthalic or terephthalic acid, 1,2-di(p-carboxyphenyl)ethane, 4,4′-dicarboxydiphenyl ether, etc., and mixtures of these. All of these acids contain at least one aromatic nucleus. Fused rings can also be present such as in 1,4- or 1,5- or 2,6-naphthalene-dicarboxylic acids. In one embodiment, the dicarboxylic acid is terephthalic acid or mixtures of terephthalic and isophthalic acid.

Polyesters that may be used in the polymer composition, for instance, include modified polyethylene terephthalate, polybutylene terephthalate, mixtures thereof and particularly copolymers thereof.

The transparent and/or translucent polyester selected for use in the polymer composition generally comprises a low crystalline polyester or a substantially amorphous polyester. A substantially amorphous polyester is a polyester that contains less than 10% crystallinity. In one embodiment, for instance, the thermoplastic polymer may contain less than about 10% crystallinity, such as less than about 5% crystallinity, such as less than about 3% crystallinity. In one embodiment, the thermoplastic polymer may be completely amorphous.

Those skilled in the art will appreciate that the degree of crystallinity of a given polyester will very much depend upon the molecular structure of the polyester. In particular, the degree of crystallinity of a polyester can be altered by changing the amount and/or type and/or distribution of monomer units that make up the polyester chain. For example, if about 3 to about 15 mole percent of the ethylene glycol repeat units in polyethylene terephthalate are replaced with 1,4-cydohexanedimethanol repeat units, or by di-ethylene glycol repeat units, the resulting modified polyester can be amorphous and has a low melt processing temperature. Similarly, if about 10 to about 20 mole percent of the terephthalic acid repeat units in polyethylene terephthalate (or polybutylene terephthalate) are replaced with isophthalic acid repeat units, the resulting modified polyester can also be amorphous and have a low melt processing temperature. Such concepts can also be combined into one polyester or by melt mixing at least 2 different polyesters. Accordingly, the choice of a particular modifying acid or diol can significantly affect the melt processing properties of the polyester.

As used herein, the terms “modifying acid” and “modifying diol” are meant to define compounds, which can form part of the acid and diol repeat units of a polyester, respectively, and which can modify a polyester to reduce its crystallinity or render the polyester amorphous.

Examples of modifying acid components may include, but are not limited to, isophthalic acid, phthalic acid, 1,3-cyclohexanedicarboxylic acid, 1,4-cyclohexane dicarboxylic acid, 2,6-naphthaline dicarboxylic acid, succinic acid, glutaric acid, adipic acid, sebacic acid, suberic acid, 1,12-dodecanedioic acid, and the like. In practice, it is often preferable to use a functional acid derivative thereof such as the dimethyl, diethyl, or dipropyl ester of the dicarboxylic acid. The anhydrides or acid halides of these acids also may be employed where practical. Preferred is isophthalic acid.

Examples of modifying diol components may include, but are not limited to, neopentyl glycol, 1,4-cyclohexanedimethanol, 1,2-propanediol, 1,3-propanediol, 2-Methy-1,3-propanediol, 1,4-butanediol, 1,6-hexanediol, 1,2-cyclohexanediol, 1,4-cyclohexanediol, 1,2-cyclohexanedimethanol, 1,3-cyclohexanedimethanol, 2,2,4,4-tetramethyl 1,3-cyclobutane diol, Z,8-bis(hydroxymethyltricyclo-[5.2.1.0]-decane wherein Z represents 3, 4, or 5; 1,4-Bis(2-hydroxyethoxy)benzene, 4,4′-Bis(2-hydroxyethoxy) diphenylether [Bis-hydroxyethyl Bisphenol A], 4,4′-Bis(2-hydroxyethoxy)diphenylsulfide [Bis-hydroxyethyl Bisphenol S] and diols containing one or more oxygen atoms in the chain, e.g. diethylene glycol, triethylene glycol, dipropylene glycol, tripropylene glycol, and the like. In general, these diols contain 2 to 18, preferably 2 to 8 carbon atoms. Cycloalphatic diols can be employed in their cis or trans configuration or as mixtures of both forms.

Other suitable low melt processing polyesters are based on polyaddition of lactones, for example poly-ε-caprolacton.

In one embodiment, a polyester suitable for use in the composition is glycol modified polyethylene terephthalate) (PET-G), poly-ε-caprolactone, or a copolyester containing greater than about 15% isophthalic units.

In one embodiment, for instance, the polyester used in the polymer composition comprises a glycol-modified polyethylene terephthalate in which the glycol is replaced with cyclohexane dimethanol or with neopentyl glycol. For instance, in one embodiment, from about 10 percent to about 50 mol percent, such as from about 20 mol percent to about 40 mol percent of the ethylene glycol is replaced with cyclohexane dimethanol. In an alternative embodiment, from about 5 mol percent to about 20 mol percent, and particularly from about 8 mol percent to about 15 mol percent of the ethylene glycol may be replaced with neopentyl glycol or 2-methyl-1,3-propane diol. In certain embodiments, there may be advantages in using a polyester modified with cyclohexane dimethanol or with neopentyl glycol or with 2-methyl-1,3-propane diol. Copolyesters modified with cyclohexane dimethanol, for instance, have demonstrated excellent impact resistance. Unexpectedly, however, the use of a neopentyl glycol or 2-methyl-1,3-propane diol modified polyester may improve stress fracture resistance.

The polyester or copolyester present in the composition can generally have an intrinsic viscosity (IV) of from about 0.5 to about 0.9 dL/g, such as from about 0.5 to about 0.8 dL/g. In one embodiment, for instance, the intrinsic viscosity of the polyester is from about 0.55 to about 0.65 dL/g.

As described above, the substantially amorphous polyester is present in the polymer composition in an amount sufficient to form a continuous phase. For example, the thermoplastic polymer may be present in the polymer composition in an amount of at least about 40% by weight, such as at least about 50% by weight, such as at least about 60% by weight. The thermoplastic polymer is generally present in an amount less than about 80% by weight.

The melt flow rate (MFR) of the thermoplastic polymer can vary depending upon the particular application. In one embodiment, for instance, when tested according to ISO Test 1133, the thermoplastic polymer may have an MFR at 200° C. and at a load of 2.16 kg of from about 30 g/10 minutes to about 70 g110 minutes, such as from about 40 g/10 minutes to about 55 g/10 minutes.

In addition to the thermoplastic polymer, the polymer composition may also contain one or more impact modifiers. In one embodiment, for instance, an impact modifier may be added that comprises a diene-based elastomer.

In one embodiment, for instance, the impact modifier may comprise a core-shell modifier that includes an elastomeric core surrounded by a thermoplastic shell. The core, for instance, may comprise a crosslinked diene-based elastomer. The particle size of the impact modifier may generally range from about 0.002 microns to about 50 microns. The impact modifier increases impact strength while also reducing the temperature dependency of the flexural modulus.

The impact modifiers may contain both a rubbery component and a grafted rigid phase component. The impact modifiers may be prepared by grafting a (meth)acrylate and/or a vinyl aromatic polymer, including copolymers thereof such as styrene/acrylonitrile, onto the selected rubber. In one embodiment, the graft polymer is a homo- or copolymer of methyl methacrylate.

For example, the vinyl aromatic core-shell impact modifiers may contain shells derived from copolymers of vinyl aromatic monomers with certain hydroxyalkyl (meth)acrylates, for example, hydroxyethyl (meth)acrylate (HEMA), hydroxypropyl (meth)acrylate (HPMA), 4-hydroxybutyl acrylate, ethyl alpha-hydroxymethylacrylate, or hydroxyethyl acrylate (HEA), or other copolymerizable monomers containing one or more hydroxyl groups, such as allyl cellosolve, allyl carbinol, methylvinyl carbinol, allyl alcohol, methallyl alcohol, and the like. Also included are other monomers which function in a similar manner, for example, glycidyl methacrylate (GMA), 3,4-epoxybutyl acrylate, acrylonitrile, methacrylonitrile, beta-cyanoethyl methacrylate, betacyanoethyl acrylate, cyanoalkoxyalkyl(meth)acrylates, such as omega-cyanoethoxyethyl acrylate, or omega-cyanoethoxyethyl methacrylate, (meth)acrylamides, such as methacrylamide or acrylamide, N-monoalkyl(meth)acrylamides, such as N-methylacrylamide or N-t-butylacrylamide or N-ethyl(meth)acrylamide, or vinyl monomers containing an aromatic ring and an hydroxyl group, preferably nonphenolic, such as vinylphenol, para-vinylbenzyl alcohol, meta-vinylphenethyl alcohol, and the like.

The rubber or elastomeric material can be, for example, one or more of the butadiene-, butyl acrylate-, or EPDM-types. The core polymer in the impact modifier composition is a rubbery polymer and generally comprises a copolymer of butadiene and a vinyl aromatic monomer. The rubbery polymer may include diene rubber copolymers (e.g., butadiene-styrene copolymer, butadiene-styrene-(meth)acrylate terpolymers, butadiene-styrene acrylonitrile terpolymers, isoprene-styrene copolymers, etc.). In one embodiment, a butadiene-vinyl aromatic copolymer latex obtained as a result of emulsion polymerization is used. In the core polymer, a partially crosslinked polymer can also be employed if crosslinking is moderate. Further, at least one of a cross- or graft-linking monomer, otherwise described as a multi-functional unsaturated monomer, can also be employed. Such monomers include divinylbenzene, diallyl maleate, butylene glycol diacrylate, allyl methacrylate, and the like.

In one embodiment, the impact modifier contains as an elastomer a substrate polymer latex or core which is made by polymerizing a conjugated diene, or by copolymerizing a conjugated diene with a mono-olefin or polar vinyl compound, such as styrene, acrylonitrile or methyl methacrylate. A mixture of monomers is then graft polymerized to the substrate latex. A variety of monomers may be used for this grafting purpose such as those discussed above, including a C1-C8 alkyl(meth)acrylate such as methyl acrylate, ethylacrylate, hexyl acrylate, methyl methacrylate, ethyl methacrylate or hexyl methacrylate; an acrylic or methacrylic acid; or a mixture of two or more of the foregoing. The extent of grafting is sensitive to the substrate latex particle size and grafting reaction conditions, and particle size may be influenced by controlled coagulation techniques among other methods. The rigid phase may be crosslinked during the polymerization by incorporation of various polyvinyl monomers such as divinyl benzene and the like.

The grafting monomers may be added to the reaction mixture simultaneously or in sequence, and, when added in sequence, layers, shells or wart-like appendages can be built up around the substrate latex, or core. The monomers can be added in various ratios to each other.

In one embodiment, the impact modifier comprises an MBS material that includes a graft copolymer formed between a butadiene polymer core and at least one vinyl monomer such as a derivative of acrylic or methacrylic acid. In one embodiment, more than one vinyl monomer is grafted to the butadiene elastomer. For instance, in one embodiment, a three-stage polymer is used having a butadiene-based core, a second-stage polymerized from styrene and a final stage or shell polymerized from methylmethacrylate and 1,3-butylene glycol dimethacrylate.

In accordance with the present disclosure, the monomer concentrations in the core and shell of the impact modifier can be adjusted in order to adjust the refractive index (RI) of the composition. More particularly, the refractive index of the impact modifier is adjusted in order to match the refractive index of the thermoplastic polymer. In this way, the impact modifier can be combined with the thermoplastic polymer, such as the substantially amorphous polyester polymer, without substantially and adversely impacting the transparent and/or translucent properties of the thermoplastic polymer.

For instance, the refractive index of the thermoplastic polymer may be from about 1.5 to about 1.6, and particularly from about 1.55 to about 1.58. The refractive index of the impact modifier can then be adjusted in accordance with the present disclosure so as to be within about 5% (higher or lower) of the refractive index of the thermoplastic polymer. In one embodiment, for instance, the refractive index of the impact modifier may be within 3%, such as within 2%, such as even within 1% of the refractive index of the thermoplastic polymer.

In one embodiment, in order to adjust the refractive index of the impact modifier, the rubber phase concentration is kept relatively low.

For instance, the rubbery polymer in the impact modifier may be a butadiene which can have a refractive index of from about 1.5 to about 1.54. The impact modifier may also contain styrene which can be used to increase the refractive index of the butadiene. For instance, the butadiene:styrene ratio in the impact modifier may be adjusted to be from about 30:70 to about 10:90, such as from about 25:75 to about 15:85. In one embodiment, for instance, the butadiene:styrene ratio can be about 20:80 which has been found to produce impact modifiers having a refractive index of from about 1.55 to about 1.58.

As described above, in one embodiment, an MBS impact modifier is used in which methyl methacrylate and styrene are grafted onto a polybutadiene backbone. It has been discovered that an MBS polymer provides advantages over an ABS polymer. MBS impact modifiers, for instance, can be made with higher clarity and have better resistance to discoloration, especially in the presence of ultraviolet light. Methyl methacrylate is believed to inhibit or at least retard oxidative attack due to ultraviolet light.

In one embodiment, the impact modifier contains from about 40% to about 90% by weight of a core polymer and from about 60% to about 10% by weight of a shell polymer.

In general, the impact modifier is present in the polymer composition in an amount of greater than about 15% by weight, such as in an amount greater than 17% by weight, such as in an amount greater than about 20% by weight. In some embodiments, the impact modifier is present in an amount greater than about 25% by weight, such as in an amount greater than 30% by weight, such as in an amount greater than about 35% by weight. The above impact modifier may be present in an amount of generally less than about 50% by weight, such as in an amount less than about 45% by weight.

In addition to the above components, the polymer composition may include various other ingredients. Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 2 percent by weight.

In one embodiment, filler particles may be incorporated into the polymer composition in order to improve scratch resistance. For instance, in one embodiment, silica particles may be incorporated into the polymer composition in order to improve scratch resistance without substantially and adversely interfering with the transparent and/or translucent properties of the composition.

In one embodiment, an anti-scratch agent is used that comprises a powdered silica, such as a fumed silica. The silica can have a refractive index that matches the refractive index of the translucent and/or transparent thermoplastic polymer present in the composition. For instance, a silica powder may be selected that is within about 5%, such as within about 3%, such as within about 1% of the refractive index of the thermoplastic polymer. In one embodiment, the silica may include a functionalized or rougher surface to reduce internal reflectance at the additive-polymer interface.

The anti-scratch additive can generally have a relatively small particle size. For instance, silica particles may be used that have an average diameter of less than about 0.5 microns. At smaller diameters, light scattering within the composition becomes negligible. Using smaller particles also produces smaller sites where the additive and polymer interface, which can also inhibit interference with the translucent properties of the composition.

In one embodiment, a hydrophilic or hydrophobic fumed silica is used that has a BET surface area of from about 100 m²/g to about 300 m²/g, such as from about 125 m²/g to about 250 m²/g. As described above, in one embodiment, the anti-scratch additive may have a functionalized surface. In this regard, in one embodiment, a silica may be used that has been surface treated with a polymer. The polymer may comprise a siloxane. For instance, in one embodiment, a hydrophobic fumed silica may be used that has been surface treated with octamethylcyclotetrasiloxane.

In other embodiments, silica particles may be used as the anti-scratch additive that have been surface treated so as to include hydroxyl groups on the surface. In other embodiments, the silica particles may include a surface treatment comprising a silane. The silane may comprise hexamethyldisilazane or dimethyldichlorosilane. The silica particles may have a pH (when submerged in distilled water) of less than about 5.5, such as less than about 5. In one embodiment, the pH may be from about 3 to about 6.

When present, the anti-scratch additive may be present in the polymer composition in an amount less than about 10% by weight, such as in an amount less than about 7% by weight, such as in an amount less than about 5% by weight, such as in an amount less than about 3% by weight. For instance, the anti-scratch additive may be present in an amount from about 0.5% to about 3% by weight, such as from about 1% to about 2.5% by weight.

In addition to an anti-scratch additive, the polymer composition may contain an optical additive that provides the polymer composition with a glitter-like appearance. The optical additive may comprise particles that are capable of scattering light in all directions. For instance, in one embodiment, a titanium dioxide particle may be used that has a particle size of from about 20 microns to about 700 microns. In one particular embodiment, the optical additive may comprise a material, such as mica, coated with titanium dioxide. The optical additive may be present in the composition in an amount less than about 5% by weight, such as in an amount less than about 3% by weight, such as in an amount less than about 2% by weight, The optical additive, for instance, may be present in an amount from about 0.05% to about 2% by weight, such as from about 0.05% to about 1% by weight.

The polymer composition may also contain at least one stabilizer. The stabilizer may comprise an antioxidant, a light stabilizer such as an ultraviolet light stabilizer, a thermal stabilizer, and the like. Stabilizers that may be added to the composition include benzotriazoles and oligomeric hindered amines.

In one embodiment, a stabilizer that may be present in the composition is an antioxidant, such as a sterically hindered phenol compound. Examples of such compounds, which are available commercially, are pentaerythrityl tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate] (Irganox 259, BASF), and 3,5-di-tert-butyl-4-hydroxytoluene (Lowinox BHT, Chemtura). In one embodiment, for instance, the antioxidant comprises tetrakis[methylene(3,5-di-tert-butyl-4-hydroxyhydrocinnamate)]methane.

Light stabilizers that may be present in the composition include sterically hindered amines. Such compounds include 2,2,6,6-tetramethyl-4-piperidyl compounds, e.g., bis(2,2,6,6-tetramethyl-4-piperidyl)sebacate (Tinuvin 770, BASF) or the polymer of dimethyl succinate and 1-(2-hydroxyethyl)-4-hydroxy-2,2,6,6-tetramethyl-4-piperidine (Tinuvin 622, BASF). UV stabilizers or absorbers that may be present in the composition include benzophenones or benzotriazoles.

In one embodiment, the polymer composition may contain a blend of stabilizers that produce ultraviolet resistance and color stability. The combination of stabilizers may allow for products to be produced, such as ski boots, that have bright and fluorescent colors. In addition, bright colored products can be produced without experiencing significant color fading over time. In one embodiment, for instance, the polymer composition may contain a combination of a benzotriazole light stabilizer and a hindered amine light stabilizer, such as an oligomeric hindered amine.

Various other stabilizers may also be present in the composition. For instance, in one embodiment, the composition may contain a phosphite, such as a diphosphite. For instance, in one embodiment, the phosphite compound may comprise distearyl pentaerythritol diphosphite. The phosphite compound may also comprise bis(2,4-ditert-butylphenyl)pentaerythritol diphosphite.

Each stabilizer above may be present in an amount from about 0.1% to about 3% by weight, such as from about 0.5% to about 1.5% by weight.

The polymer composition may also contain at least one plasticizer. The plasticizer may comprise a liquid plasticizer or a solid plasticizer. The plasticizer may comprise a polyethylene glycol dilaurate, a sulfonamide such as n-butylbenzene sulfonamide, a benzoate such as neopentyl gelycol dibenzote, and the like. The plasticizer may impart flexibility, provide moisture resistance, and provide solvent resistance. The plasticizer may be present in an amount of at least 0% by weight, such as at least 2.5%, such as at least 5%, such as at least 7.5% and less than about 15%, such as less than about 12.5%, such as less than about 10%.

In order to produce molded articles in accordance with the present disclosure, the different components of the polymer composition can be dry blended together in a drum tumbler or in a high intensity mixer. The premixed blends can then be melt blended and extruded as pellets. The pellets can then be used in an injection molding process.

The flexural modulus of the polymer composition may generally range from about 200 MPa to about 2500 MPa, such as from about 700 MPa to about 2000 MPa at 23° C.

For transparent plastic materials, transparency may be defined as the state permitting perception of objects through or beyond the specimen. It is often assessed as that fraction of the normally incident light transmitted with deviation from the primary beam direction of less than 0.1 degree. In addition to transmittance, there are a number of other optical properties that may be evaluated. These other properties include clarity, haze, birefringence, color, refractive index, and reflectance.

In order to achieve clarity with respect to polymer compositions of the present disclosure, the different components are formulated such that they each have a complimentary refractive index. For instance, in one embodiment, the polymer composition is formulated so that the refractive index is constant throughout the sample in the line of direction between the object in view and the eye. The presence of interfaces between regions of different materials can cause scatter of light rays. In one embodiment, scatter is minimized while still producing a translucent material with excellent physical properties.

When light falls on a material, some of the light is transmitted, some is reflected and some is absorbed. The transmittance is the ratio of the light passing through to the light incident on the specimen and the reflectance is the ratio of the light reflected to the light incident. The gloss is a function of the reflectance and the surface finish of the material. Where transmittance and reflectance do not add up to unity then some of the light is being absorbed. The uneven absorption of incident light can result in the material displaying a color.

In accordance with the present disclosure, the refractive index is measured using the Becke Line Method. Refractive index standard oils differing in increments of 0.0040 n can be utilized. Use of a 10× N plan objective, bright field and condenser iris diaphragm in the closed position enables observation of the Becke line. In order to measure the Becke line, the samples can be cut into small pieces having a dimension of less than 2 millimeters. The small piece of sample is placed in the oil and covered with a cover slip. If the Becke line moved into the oil when the stage was lowered, oil with lower refractive index was selected for the next attempt. If the Becke line moved into the sample when the stage was lowered, oil with a higher refractive index was selected. This iterative process can be followed until the Becke line is no longer observed or the refractive index of the sample was found to be between two oils with adjacent refractive index values (a difference of 0.0040). In general, glycol modified polyesters can have a refractive index value of from about 1.56 to about 1.6. As described above, the impact modifier can be formulated so as to substantially match the refractive index of the thermoplastic polymer. When an anti-scratch agent is present, an additive can be selected that also matches the refractive index of the thermoplastic polymer.

Polymer compositions formulated in accordance with the present disclosure not only have excellent transmission properties in the visible light range, but also can be formulated so as to substantially prevent ultraviolet light from passing through the material. In one embodiment, for instance, the polymer composition may display a maximum transmission between a light wavelength range of from about 400 nm to about 900 nm of more than about 60%, such as more than about 62%, such as more than about 65%. Of particular advantage, polymer compositions made in accordance with the present disclosure may also have a transmission of 0% at one wavelength less than about 400 nm. Allowing significant amounts of visible light to transmit through the material while preventing UV light can offer many advantages and benefits when used in various commercial applications.

In addition to the above, the polymer composition can also have excellent impact resistance. For instance, when tested according to the notched Charpy test at 23° C., the polymer composition may have an impact resistance of at least about 3 kJ/m², such as at least about 3.5 kJ/m², such as at least about 4 kJ/m², such as at least about 4.5 kJ/m², such as at least about 5 kJ/m², such as at least about 5.5 kJ/m², such as at least about 6 kJ/m², such as at least about 6.5 kJ/m², such as at least about 7 kJ/m², such as at least about 7.5 kJ/m², such as at least about 8 kJ/m² (generally less than 15 kJ/m², such as less than 12 kJ/m²).

The polymer composition of the present disclosure may also have great abrasion resistance while having a Shore D hardness of from about 70 to about 75. For instance, the polymer composition may have an abrasion resistance when tested according to Taber Test H18 after 10,000 cycles of less than about 45 milligrams, such as less than about 25 milligrams.

The polymer composition can also have a deflection temperature under load of greater than about 62° C., such as greater than about 65° C.

The polymer composition of the present disclosure may be used in numerous applications. The polymer composition is solvent resistant, has high heat resistance, excellent elongation, high strength and modulus. In one embodiment, the polymer composition may be used to produce translucent ski boots that have a relatively low rigidity factor. For instance, the polymer composition can have a rigidity factor of 2 or less, such as 1.5 or less, such as 1.3 or less.

The rigidity factor of a polymer composition is calculated by dividing the flexural modulus of the polymer composition at −20° C. by the flexural modulus of the composition at 23° C. As used herein, the flexural modulus is determined according to ISO Test 178. The rigidity factor is an indication of the temperature dependent behavior of the polymer composition at lower temperatures. A rigidity factor of less than 2 is an indication that the polymer composition is stable at lower temperatures over a wide temperature range and does not significantly change in stiffness or performance.

In order to produce a polymer composition having a rigidity factor of about 2 or less, the different components contained in the polymer composition of the present disclosure are selected based upon their individual properties. In particular, in one embodiment, the thermoplastic polymer, a thermoplastic elastomer, and an impact modifier are selected such that none of the above polymers undergo a glass transition or undergo any other second order transition at a temperature range of from about 50° C. to about −40° C., and particularly from about 37° C. to about −30° C.

In addition to ski boots, the polymer composition can also be used to produce various other products, such as keyboard cap keys, gaming consoles, lamp covers, automotive parts, and the like. The polymer composition may be used for swimming pool pump housings and filtration systems, cosmetic packaging, toothbrush handles, consumer appliance products including handles, and the like. The polymer composition can also be used to coat other materials.

The present disclosure may be better understood with reference to the following examples.

The following polymer compositions were formulated and dry blended together in a drum tumbler.

| | Samples (Weight %) | | | | | | |
|---|---|---|---|---|---|---|---|
| | Sample | Sample | Sample | Sample | Sample | Sample | Sample |
| Formulation | No. 1 | No. 2 | No. 3 | No. 4 | No. 5 | No. 6 | No. 7 |
| polyethylene terephthalate | 67.9 | 74.3 | | | 68.3 | | |
| glycol | | | | | | | |
| (100 mol % Terephthalic acid) | | | | | | | |
| (31 mol % cyclohexane | | | | | | | |
| dimethanol, CHDM) (69 mol | | | | | | | |
| % ethylene glycol) | | | | | | | |
| polyethylene terephthalate | | | | 74.3 | | 68.3 | 72.95 |
| glycol (11 mol % neopentyl glycol) | | | | | | | |
| 30 mol % isophthalate | | | 74.3 | | | | |
| modified polyethylene | | | | | | | |
| terephthalate (30% of | | | | | | | |
| terephthalic acid substituted | | | | | | | |
| with isophthalic acid) | | | | | | | |
| MBS core-shell | 30 | 25 | 25 | 25 | 30 | 30 | 25 |
| Impact modifier | | | | | | | |
| tetrakis[methylene-β-(3,5-di- | 0.3 | 0.3 | 0.3 | 0.3 | 0.3 | 0.3 | 0.3 |
| tert-butyl-4-hydroxy phenyl)- | | | | | | | |
| propionate] methane | | | | | | | |
| bis-(2,4-di-t-butylphenol) | 0.2 | 0.2 | 0.2 | 0.2 | | | |
| pentaerythritol diphosphite, | | | | | | | |
| antioxidant | | | | | | | |
| Thioether, Used for | | | | | 0.2 | 0.2 | 0.2 |
| polyolefins | | | | | | | |
| hydrophobic fumed silica | | | | | 1 | 1 | 1 |
| modified with | | | | | | | |
| hexamethyldisilazane (BET | | | | | | | |
| surface area of approx. | | | | | | | |
| 160 m²/g) | | | | | | | |
| 2,5-thiophenediylbis(5-tert- | 0.1 | 0.2 | 0.2 | 0.2 | 0.2 | 0.2 | 0.2 |
| butyl-1,3-benzoxazole), | | | | | | | |
| optical brightners | | | | | | | |
| 2-(2-Hydroxy-5-octylphenyl)- | 0.75 | | | | | | |
| benzotriazole, light stabilizer | | | | | | | |
| Polymer of 2,2,4,4- | 0.75 | | | | | | |
| tetramethyl-7-oxa-3,20-diaza- | | | | | | | |
| dispiro [5.1.11.2]- | | | | | | | |
| heneicosan-21-on and | | | | | | | |
| epichlorohydrin, light stabilizer | | | | | | | |
| 2,2′-(1,4-Phenylene)bis | | | | | | | 0.35 |
| [4H-3,1-Benzoxazin-4-one] | | | | | | | |
| | Samples (Weight %) | | | | | | |
| | Sample | Sample | Sample | Sample | Sample | Sample | Sample |
| Formulation | No. 8 | No. 9 | No. 10 | No. 11 | No. 12 | No. 13 | No. 14 |
| polyethylene terephthalate | | 59.6 | 57.7 | 57.7 | 57.7 | 57.7 | |
| glycol | | | | | | | |
| (100 mol % terephthalic acid) | | | | | | | |
| (31 mol % cyclohexane | | | | | | | |
| dimethanol, CHDM) (69 mol % | | | | | | | |
| ethylene glycol) | | | | | | | |
| polyethylene terephthalate | 68.3 | | | | | | 56.8 |
| glycol (11 mol % neopentyl | | | | | | | |
| glycol) | | | | | | | |
| MBS core-shell | 30 | 40 | 40 | 40 | 40 | 40 | 40 |
| impact modifier | | | | | | | |
| tetrakis[methylene-β-(3,5-di- | 0.3 | 0.2 | 0.2 | 0.2 | 0.2 | 0.2 | 0.3 |
| tert-butyl-4-hydroxy phenyl)- | | | | | | | |
| propionate] methane | | | | | | | |
| bis-(2,4-di-t-butylphenol) | | 0.1 | 0.1 | 0.1 | 0.1 | 0.1 | 0.2 |
| pentaerythritol diphosphite, | | | | | | | |
| antioxidant | | | | | | | |
| Thioether, Used for | 0.2 | | | | | | |
| polyolefins | | | | | | | |
| hydrophobic fumed silica | | | | | 2 | | 2 |
| modified with | | | | | | | |
| hexamethyldisilazane | | | | | | | |
| 2,5-thiophenediylbis(5-tert- | 0.2 | | | | | | |
| butyl-1,3-benzoxazole), | | | | | | | |
| optical brightners | | | | | | | |
| 2,2′-(1,4-Phenylene)bis | | | | | | | 0.7 |
| [4H-3,1-Benzoxazin-4-one] | | | | | | | |
| hydrophillic fumed silica | 1 | | | 2 | | | |
| modified with hydroxyl groups | | | | | | | |
| with a specific surface area of | | | | | | | |
| 200 m²/g, functional | | | | | | | |
| hydrophillic fumed silica | | | 2 | | | | |
| modified with hydroxyl groups | | | | | | | |
| with a specific surface area of | | | | | | | |
| 150 m²/g, functional | | | | | | | |
| hydrophobic fumed silica | | | | | | 2 | |
| treated with | | | | | | | |
| Octamethylcyclotetrasiloxane | | | | | | | |
| with a surface area of 150 m²/g | | | | | | | |
| Mica coated with titanium | | 0.1 | | | | | |
| dioxide (visual effect, glitter) | | | | | | | |

| | Samples (Weight %) | | | | |
|---|---|---|---|---|---|
| | Sample | Sample | Sample | Sample | Sample |
| Formulation | No. 15 | No. 16 | No. 17 | No. 18 | No. 19 |
| polyethylene terephthalate | 69.7 | 69.7 | | | 64.7 |
| glycol | | | | | |
| (100 mol % Terephthalic acid) | | | | | |
| (31 mol % cyclohexane | | | | | |
| dimethanol, CHDM) (69 mol | | | | | |
| % ethylene glycol) | | | | | |
| copolyester (dicarboxylic acid | | | 74.7 | 74.7 | |
| component; 2,2,4,4- | | | | | |
| tetramethyl-1,3- | | | | | |
| cyclobutanediol (15-40%); | | | | | |
| and 1,4- | | | | | |
| cyclohexanedimethanol (15-40%)) | | | | | |
| MBS core-shell | 25 | 25 | 25 | 25 | 25 |
| impact modifier | | | | | |
| tetrakis[methylene-β-(3,5-di- | 0.1 | 0.1 | 0.1 | 0.1 | 0.1 |
| tert-butyl-4-hydroxy phenyl)- | | | | | |
| propionate] methane | | | | | |
| bis-(2,4-di-t-butylphenol) | 0.1 | 0.1 | 0.1 | 0.1 | 0.1 |
| pentaerythritol diphosphite, | | | | | |
| antioxidant | | | | | |
| 2,5-thiophenediylbis(5-tert- | 0.1 | 0.1 | 0.1 | 0.1 | 0.1 |
| butyl-1,3-benzoxazole), | | | | | |
| optical brightners | | | | | |
| polyethylene glycol 600 | | 5 | | | |
| dilaurate | | | | | |
| neopentyl glycol dibenzoate | 5 | | | | 10 |

| | Samples (Weight %) | | |
|---|---|---|---|
| | Sample | Sample | Sample |
| Formulation | No. 20 | No. 21 | No. 22 |
| polyethylene terephthalate | 74.8 | 69.8 | 64.8 |
| glycol | | | |
| (100 mol % Terephthalic acid) | | | |
| (31 mol % cyclohexane | | | |
| dimethanol, CHDM) (69 mol | | | |
| % ethylene glycol) | | | |
| MBS core-shell | 25 | 25 | 25 |
| impact modifier | | | |
| tetrakis[methylene-β-(3,5-di- | 0.1 | 0.1 | 0.1 |
| tert-butyl-4-hydroxy phenyl)- | | | |
| propionate] methane | | | |
| bis-(2,4-di-t-butylphenol) | 0.1 | 0.1 | 0.1 |
| pentaerythritol diphosphite, | | | |
| antioxidant | | | |
| N-Butylbenzenesulfonamide | | 5 | 10 |

The premixed ingredients were melt-blended and extruded as pellets in a WLE-25 extruder having a SC-202 screw design under the following temperature settings:

| Barrel Zone | Temp. Setting (° C.) |
|---|---|
| 1 | 230-235 |
| 2 | 230-235 |
| 3 | 230-240 |
| 4 | 230-240 |
| 5 | 235-250 |
| 6 | 235-254 |
| Die head temp | 245 |
| Melt Temp | 240 |

The screw speed was set at, for example 375 RPM with 50% torque. A typical die vacuum was 20 mm of Hg and throughput was 50 lbs/hr.

Each of the formulations was conventionally injection molded after drying of pellets at 120 C for 4 hr. for example using a 4 oz. Demag 661 molding machine. The temperature settings were as follows:

| Zone | Temperature Setting (° C.) |
|---|---|
| Rear Barrel | 220-235 |
| Middle Barrel | 220-240 |
| Front Barrel | 225-240 |
| Nozzle | 225-245 |
| Melt | 225-245 |
| Moveable Mold | 20-40 |
| Stationary Mold | 20-40 |

The following results were obtained:

| | | Samples | | | | | | |
|---|---|---|---|---|---|---|---|---|
| | | Sample | Sample | Sample | Sample | Sample | Sample | Sample |
| Properties | unit | No. 1 | No. 2 | No. 3 | No. 4 | No. 5 | No. 6 | No. 7 |
| MFR 250° C./2.16 kg | [g/10 min] | 2.44 | 0.5 | 0.99 | 0.45 | 2.1 | 6.55 | 8.07 |
| Flex Modulus | [MPa] | 1510 | 1704 | 2021 | 1825 | 1625 | 1888 | 1865 |
| (@23° C.) | | | | | | | | |
| Flex Modulus | [MPa] | 1732 | 1978 | 2365 | 2079 | | | |
| (@−20° C.) | | | | | | | | |
| ISO Tensile | [MPa] | 1608 | 1573 | 2158 | 1927 | 1442 | 1650 | 1696 |
| Modulus (@23° C.) | | | | | | | | |
| ISO Tensile | [%] | 3.95 | 4.1 | 3.52 | 3.65 | 4.1 | 3.7 | 3.77 |
| Strain-yield | | | | | | | | |
| ISO Tensile | [%] | 36.51 | 39.47 | 45.05 | 41.17 | 36 | 38 | 39 |
| Stress-yield | | | | | | | | |
| Notched Charpy | [kJ/m²] | 9.4 | 8.8 | 2.4 | 6.7 | 9.4 | 4.9 | 5.2 |
| (@23° C.) | | | | | | | | |
| Notched Charpy | [kJ/m²] | 1.5 | 2 | 1.2 | 1.2 | 1.1 | 1.3 | 1.1 |
| (@−30° C.) | | | | | | | | |
| Rigidity Factor | — | 1.14 | 1.16 | 1.17 | 1.13 | | | |
| | | Samples | | | | | | |
| | | Sample | Sample | Sample | Sample | Sample | Sample | Sample |
| Properties | unit | No. 8 | No. 9 | No. 10 | No. 11 | No. 12 | No. 13 | No. 14 |
| MFR 250° C./2.16 kg | [g/10 min] | 0.51 | 0.25 | 0.21 | 0.2 | 0.02 | 0.27 | 0.41 |
| Flex Modulus | [MPa] | 1778 | 1485 | 1513 | 1507 | 1526 | 1504 | 1645 |
| (@23° C.) | | | | | | | | |
| Flex Modulus | [MPa] | | 1758 | 1840 | 1832 | 1756 | 1790 | 1902 |
| (@−20° C.) | | | | | | | | |
| ISO Tensile | [MPa] | 1670 | 1410 | 1524 | 1419 | 1401 | 1332 | 1492 |
| Modulus (@23° C.) | | | | | | | | |
| ISO Tensile | [%] | 3.65 | 3.89 | 3.84 | 3.86 | 3.87 | 3.89 | 3.54 |
| Strain-yield | | | | | | | | |
| ISO Tensile | [%] | 38 | 33.6 | 33.31 | 33.21 | 34.07 | 33.73 | 35.26 |
| Stress-yield | | | | | | | | |
| Notched Charpy | [kJ/m²] | 4.9 | 6.8 | 4.5 | 4.9 | 6.3 | 5.7 | 3.2 |
| (@23° C.) | | | | | | | | |
| Notched Charpy | kJ/m²] | 1 | 1.2 | 1.2 | 1.2 | 1.3 | 1.2 | 1.1 |
| (@−30° C.) | | | | | | | | |
| Rigidity Factor | — | | 1.158 | 1.164 | 1.163 | 1.166 | 1.167 | 1.179 |
| Density | [g/cm³] | | 1.18 | 1.22 | 1.22 | 1.15 | 1.19 | 1.16 |
| Hardness-Shore D | — | | 74.5 | 75.4 | 74.5 | 73.8 | 74.4 | 74.4 |
| DTUL (0.45 MPa) | [° C.] | | 67.6 | 67.8 | 67.7 | 67.5 | 67.9 | 65.5 |
| Taber-H18(K) | [mg] | | 178.8 | 182.6 | 164.2 | 171.4 | 143.9 | 102.3 |
| Taber-H18(10K) | [mg] | | 41.8 | 40.7 | 37.2 | 42.8 | 26.9 | 20.2 |

| | | Samples | | | | |
|---|---|---|---|---|---|---|
| | | Sample | Sample | Sample | Sample | Sample |
| Properties | unit | No. 15 | No. 16 | No. 17 | No. 18 | No. 19 |
| MFR 250° C./2.16 kg | [g/10 min] | 1.93 | 2.53 | 0.8 | 3.33 | 3.21 |
| Flex Modulus | [MPa] | 1745 | 1451 | 1393 | 1023 | 1591 |
| (@23° C.) | | | | | | |
| Flex Modulus | [MPa] | 2058 | 1802 | 1518 | 1165 | 2016 |
| (@−20° C.) | | | | | | |
| ISO Tensile | [MPa] | 1741 | 1491 | 1360 | 987 | 1784 |
| Modulus (@23° C.) | | | | | | |
| ISO Tensile | [%] | 3.68 | 3.93 | 5.51 | 6.34 | 3.45 |
| Strain-yield | | | | | | |
| ISO Tensile | [%] | 39.38 | 34.19 | 36.29 | 27.3 | 36.59 |
| Stress-yield | | | | | | |
| Notched Charpy | [kJ/m²] | 6.6 | 6.3 | 20 | 40.3 | 4.7 |
| (@23° C.) | | | | | | |
| Notched Charpy | [kJ/m²] | 1.4 | 2 | 2.7 | 18.6 | 1.4 |
| (@−30° C.) | | | | | | |

| | | Samples | | |
|---|---|---|---|---|
| | | Sample | Sample | Sample |
| Properties | unit | No. 20 | No. 21 | No. 22 |
| MFR 250° C./2.16 kg | [g/10 min] | 4.1 | 4.65 | 18.23 |
| Flex Modulus | [MPa] | 1709 | 1782 | 1464 |
| (@23° C.) | | | | |
| Flex Modulus | [MPa] | 1873 | 1874 | 2225 |
| (@−20° C.) | | | | |
| ISO Tensile | [MPa] | 1540 | 1678 | 1478 |
| Modulus (@23° C.) | | | | |
| ISO Tensile | [%] | 4.11 | 3.68 | 3.61 |
| Strain-yield | | | | |
| ISO Tensile | [%] | 39.87 | 41.71 | 35.15 |
| Stress-yield | | | | |
| Notched Charpy | [kJ/m²] | 8.3 | 4.4 | 2.6 |
| (@23° C.) | | | | |
| Notched Charpy | [kJ/m²] | 1.6 | 1.8 | 1.2 |
| (@−30° C.) | | | | |
| Density | [g/cm³] | 1.197 | 1.194 | 1.1967 |
| Hardness-Shore D | — | 75.5 | 75.2 | 73.3 |
| DTUL (0.45 MPa) | [° C.] | 69.8 | 54.1 | 40.9 |
| Taber-H18 (1K) | [mg] | 103.8 | 133.6 | 61.7 |
| Taber-H18(10K) | [mg] | 25 | 25.7 | 11.6 |

In the above table, flexural modulus was determined according to ISO Test 178, while the tensile tests were measured according to ISO Test 527. ISO Test 179 was used to determine notched Charpy results.

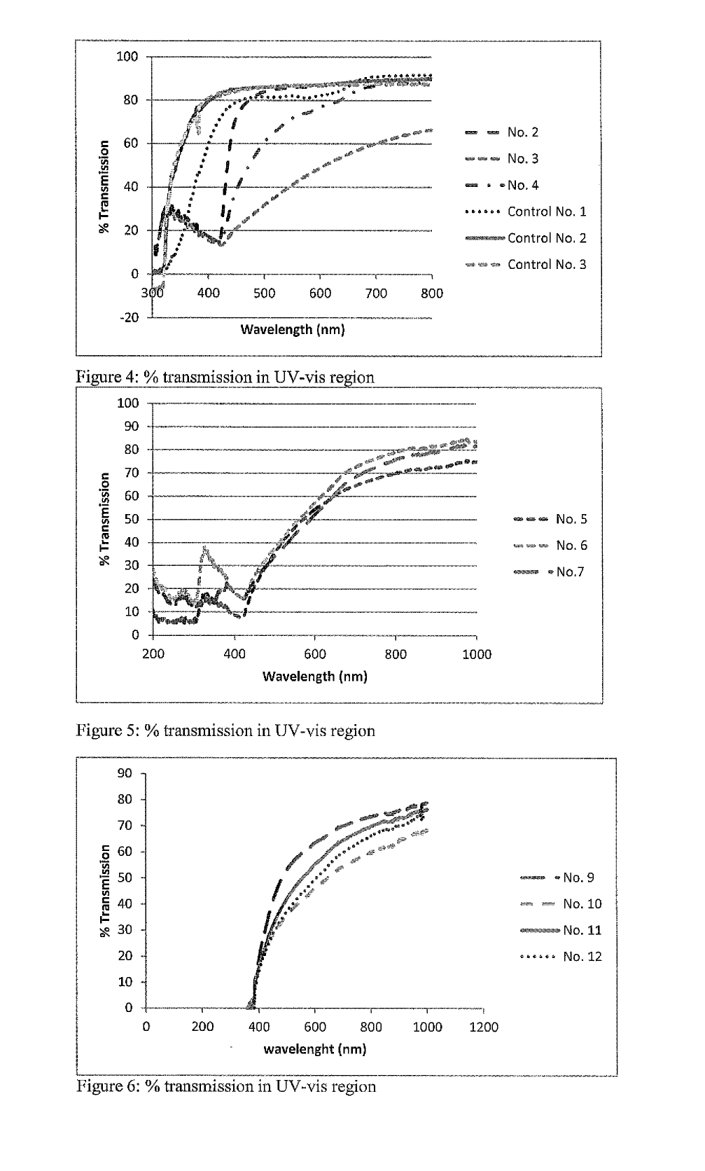

Various samples formulated above were also tested for light transmission over a wavelength range that included visible light and ultraviolet light. FIG. 4 illustrates percent transmission for Sample Nos. 2-4. FIG. 4 also includes Control No. 1 which is a light transmission curve for the CHDM modified polyethylene terephthalate. Control No. 2 is light transmission for the neopentyl glycol modified polyethylene terephthalate while Control No. 3 is percent transmission for a 30 mol % isophthalate modified PET (30% of the terephthalic acid is substituted by isophthalic acid)

FIG. 5 provides light transmission results for Sample Nos. 5-7. FIG. 6 provides the light transmission results for Sample Nos. 9-12. As shown in FIGS. 4-6, the samples made according to the present disclosure had a maximum percent transmission of greater than 60% within a wavelength range of from greater than 400 nm to about 900 nm. Unexpectedly, Sample Nos. 9-12 showed zero light transmission at wavelengths less than about 400 nm, meaning that the material substantially blocked ultraviolet rays.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A molded product comprising:
an article molded from a polymer composition, the polymer composition comprising a substantially amorphous polyester polymer present in the composition in an amount sufficient to form a continuous phase, the polyester polymer comprising a polyalkylene terephthalate copolymer, the polymer composition further comprising an impact modifier and at least one stabilizer, the impact modifier being present in the polymer composition in an amount of at least about 15% by weight, the impact modifier having a refractive index that is within about 5% of a refractive index of the polyester polymer, the polymer composition having a maximum transmission within a wavelength range of from about 400 nm to about 900 nm of greater than about 60%, the polymer composition also having a notched Charpy impact strength at 23° C. of greater than about 3.5 kJ/m².

2. A molded product as defined in claim 1, wherein the polyester polymer comprises a polyethylene terephthalate glycol-modified copolymer containing cyclohexane dimethanol.

3. A molded product as defined in claim 1, wherein the polyester polymer comprises a polyethylene terephthalate glycol-modified copolymer containing neopentyl glycol.

4. A molded product as defined in claim 1, wherein the polyester polymer comprises a polyethylene terephthalate acid-modified copolymer containing isophthalic acid.

5. A molded product as defined in claim 1, wherein the impact modifier comprises a core and shell construction, the core comprising a cross-linked diene-based elastomer, the shell comprising a thermoplastic polymer.

6. A molded product as defined in claim 4, wherein the impact modifier includes a polybutadiene grafted to a methacrylate and a styrene.

7. A molded product as defined in claim 1, wherein the polyester polymer is present in the polymer composition in an amount from about 50% to about 80% by weight and the impact modifier is present in the polymer composition in an amount from about 20% to about 45% by weight.

8. A molded product as defined in claim 1, wherein the polymer composition has an abrasion resistance according to Taber Test H18 of less than about 45 milligrams after 10,000 cycles.

9. A molded product as defined in claim 1, wherein the polymer composition has an abrasion resistance according to Taber Test H18 of less than about 25 milligrams after 10,000 cycles.

10. A molded product as defined in claim 1, wherein the polymer composition has a deflection temperature under load of 0.45 MPa greater than about 62° C.

11. A molded product as defined in claim 1, wherein the polymer composition has a Shore D hardness of from about 70 to about 80.

12. A molded product as defined in claim 1, wherein the polymer composition has a rigidity factor of about 2 or less.

13. A molded product as defined in claim 1, wherein the polymer composition further contains an anti-scratch additive, the polymer composition having 0% transmission at a wavelength less than 400 nm.

14. A molded product as defined in claim 12, wherein the anti-scratch additive comprises silica, the silica being present in the polymer composition in an amount from about 1% to about 5% by weight, the silica particles having a surface area of from about 50 m²/g to about 250 m²/g.

15. A molded product as defined in claim 1, wherein the polymer composition further comprises mica particles coated with titanium dioxide.

16. A translucent polymer composition comprising:
a non-elastomeric polyester polymer present in the composition in an amount sufficient to form a continuous phase in an article molded with the polymer composition, the polyester polymer comprising a polyalkylene terephthalate copolymer, the polyester polymer being substantially amorphous, the polyester polymer being present in the polymer composition in an amount from about 50% to about 80% by weight;
an impact modifier having a core and shell construction and being present in the polymer composition in an amount of at least about 15% by weight, the impact modifier having a refractive index that is within 5% of a refractive index of the polyester polymer;
at least one stabilizer comprising an antioxidant or an ultraviolet light stabilizer; and
wherein the polymer composition is formulated so as to have a maximum transmission within a wavelength range of from about 400 nm to about 900 nm of greater than 60%, so as to have a rigidity factor of about 2 or less, and so as to have a notched Charpy impact strength resistance of greater than about 3.5 kJ/m².

17. A polymer composition as defined in claim 16, wherein the impact modifier includes a polybutadiene grafted to a methacrylate and a styrene.

18. A polymer composition as defined in claim 16, wherein the polymer composition has an abrasion resistance according to Taber Test H18 of less than about 45 milligrams after 10,000 cycles, has a deflection temperature under load of greater than about 62° C., and has a Shore D hardness of from about 70 to about 80.

19. A polymer composition as defined in claim 16, wherein the polymer composition further contains an anti-scratch additive, the polymer composition having 0% transmission at a wavelength less than 400 nm.

20. A polymer composition as defined in claim 16, wherein the anti-scratch additive comprises silica, the silica being present in the polymer composition in an amount from about 1% to about 5% by weight, the silica particles having a surface area of from about 50 m²/g to about 250 m²/g.

21. A polymer composition as defined in claim 16, wherein the polymer composition further comprises mica particles coated with titanium dioxide.

22. A polymer composition as defined in claim 16, wherein the polyester polymer comprises a polyethylene terephthalate glycol-modified copolymer containing cyclohexane dimethanol.

23. A polymer composition as defined in claim 16, wherein the polyester polymer comprises a polyethylene terephthalate glycol-modified copolymer containing neopentyl glycol.

24. A polymer composition as defined in claim 16, wherein the polyester polymer comprises a polyethylene terephthalate acid-modified copolymer containing isophthalic acid.
